(19) United States
(12) Patent Application Publication
(10) Pub. No.: US 2008/0118169 A1
(43) Pub. Date: May 22, 2008

(54) Method for Optimizing Software Implementations of the JPEG2000 Binary Arithmetic Encoder

(76) Inventors: Oliver P. Sohm, Toronto (CA); Brian E. Valentine, Atlanta, GA (US)

Correspondence Address: TEXAS INSTRUMENTS INCORPORATED, P O BOX 655474, M/S 3999, DALLAS, TX, 75265, US

(21) Appl. No.: 11/560,406

(22) Filed: Nov. 16, 2006

(51) Int. Cl. G06K 9/36

(52) U.S. Cl. 382/247

(57) ABSTRACT

This invention is a JPEG2000 arithmetic encoder with improvements to conventional JPEG2000 encoder implementations. This invention decouples co-efficient bit modeling from arithmetic encoding, eliminates the RENORME while loop through least most bit detection, decouples encoding from BYTEOUT, exploits parallelism across conditional execution paths, uses look-up table storage and packing of context state data and eliminates memory dependencies through direct register forwarding.

### TECHNICAL FIELD OF THE INVENTION

The technical field of this invention is data compression by binary arithmetic encoding.

### BACKGROUND OF THE INVENTION

JPEG2000 is a new image compression standard that achieves higher compression and image quality compared to existing standards such as JPEG. With this higher quality however comes a dramatic increase in computational complexity. Any straightforward implementation based on the reference implementation would not meet the requirements for a commercial product. This high complexity results in long processing times and low frame rates or long delays between frames, high power consumption and high hardware cost.

FIG. 1 illustrates a block diagram of the JPEG2000 encoder which is similar to every transform-based coding scheme. Color space conversion block 101 and the wavelet transform block 102 apply data ordering to the source image data 100. Quantization 103 quantizes the transform coefficients. Coefficient bit modeling block 104 and arithmetic coding block 105 apply entropy encoding. Bit stream processing 106 completes the formation of the compressed image 107. Unlike other coding schemes, images compressed by JPEG2000 can be either lossy or lossless, depending on the wavelet transform and the quantization.

The JPEG2000 standard works on image tiles. Tiles are rectangular non-overlapping blocks partitioned from the original source image. These tiles are compressed independently, as though they were entirely distinct images. In the strongest form of spatial partitioning, all operations, including component mixing, wavelet transform, quantization and entropy coding are performed independently on the individual tiles of the image. All tiles have the same dimensions, except those on the right and lower boundary of the image which conform to the image size. The nominal tile dimensions are exact powers of two. Tiling reduces memory requirements and constitutes one of the methods for the efficient extraction of a region of the image.

Wavelet transform 102 decomposes the tiles into separate decomposition levels. These decomposition levels contain a number of sub-bands populated with coefficients that describe the horizontal and vertical spatial frequency characteristics of the original tile component planes. These coefficients provide local frequency information. A decomposition level is related to the next decomposition level by spatial powers of two. In forward discrete wavelet transform (DWT), the JPEG2000 standard uses a 1-D sub-band decomposition of a 1-D set of samples into low-pass samples, representing a down-sampled low-resolution version of the original set, and high-pass samples, representing a down-sampled residual version of the original set. Together these provide the information needed for the perfect reconstruction of the original image.

The JPEG2000 standard supports two filtering modes: a convolution-based mode; and a lifting-based mode. To implement both modes, the signal should first be extended periodically. This periodic symmetric extension ensures that for filtering operations at both boundaries of the signal, one signal sample exists and spatially corresponds to each coefficient of the filter mask. The number of additional samples required at the boundaries of the signal is therefore filter-length dependent.

Convolution-based filtering performs a series of dot products between the two filter masks and the extended 1-D signal. Lifting-based filtering is a sequence of simple filtering operations with alternately odd sample values of the signal updated with a weighted sum of even sample values, and even sample values updated with a weighted sum of odd sample values. For the reversible (lossless) case the results are rounded to integer values. The lifting-based filtering for a 5/3 analysis filter is:

$$\begin{matrix}y ( 2 n + 1 ) = {x}_{est} ( 2 n + 1 ) - [ \frac{{x}_{est} ( 2 n ) + {x}_{est} ( 2 n + 2 ) - 1}{2} ] & [ 1 A ] \\ y ( 2 n ) = {x}_{est} ( 2 n ) - [ \frac{y ( 2 n - 1 ) + y ( 2 n + 1 ) + 2}{4} ] & [ 1 B ]\end{matrix}$$

where: xₑₛₜ is the extended input signal, and y( ) is the output signal.

Quantization reduces the precision of the coefficients. This operation is lossy, unless the quantization step is 1 and the coefficients are integers. The reversible integer 5/3 wavelet is thus lossless. Each transform coefficient a_{b}(u,v) of the sub-band b is quantized to the value q_{b}(u,v) according to the formula:

$${q}_{b} ( u , v ) = sin ( {a}_{b} ( u , v ) ) [ \frac{{a}_{b} ( u , v )}{{Δ}_{b}} ] \qquad [ 2 ]$$

The dynamic range of quantization depends on the number of bits used to represent the original image tile component and on the choice of the wavelet transform. All quantized transform coefficients are signed values even when the original components are unsigned. These coefficients are expressed in a sign-magnitude representation prior to coding.

Each sub-band of the wavelet decomposition is divided into rectangular blocks called code-blocks. These code-blocks are coded independently using embedded block coding with optimized truncation (EBCOT). These code-blocks are coded one bit-plane at a time in three passes, starting with the most significant bit-plane with a non-zero element to the least significant bit-plane. For each bit-plane in a code-block, a special code-block scan pattern is used for each of three passes. Each coefficient bit in the bit-plane is coded in only one of the three passes. Code blocks are compressed using binary arithmetic encoding. A rate distortion optimization method allocates a certain number of bits to each block. The recursive probability interval subdivision of Elias coding is the basis for the binary arithmetic coding process. With each binary decision, the current probability interval is subdivided into two sub-intervals. If necessary the code-stream is modified so that it points to the base (lower bound) of the probability sub-interval assigned to the symbol which occurred. Since the coding process involves addition of binary fractions rather than concatenation of integer codewords, the more probable binary decisions can often be coded at a cost of much less than one bit per decision.

FIG. 2 illustrates the conventional JPEG2000 encoder in greater detail. Coefficient bit modeling 104 and arithmetic coding block 105 may be broken down into the functional blocks 201 through 205 shown in FIG. 2. This expanded view of coefficient bit modeling 104 and arithmetic coding 105 as described by JPEG2000 requires complex number processing which severely taxes processor performance. The entropy encoder operations include four main stages: Code MPS 201; Code LPS 202; RENORME 203; and BYTEOUT 204. These execute conditionally based on the context state of the arithmetic coder 105, its interval width and the codeword value. Arithmetic coder 105: decides if an MPS (most probable symbol) or a LPS (least probable symbol) is encoded; decides whether to renormalize the interval width and codeword; and determines if a compressed byte needs to be extracted from the codeword and exported to the embedded bitstream. The RENORME procedure is embedded inside the Code LPS and Code MPS procedures, and BYTEOUT is embedded within RENORME adding to the complexity.

Coefficient bit modeler 104 is central to JPEG2000 encoding. Coefficient bit modeler 104 and context-based binary arithmetic coder 105 can contribute about 70-80% of the overall execution time. Any efficient implementation of JPEG200 in hardware or software has to pay special attention to these two components. Other image compression algorithms, operate on a pixel level granularity, but JPEG2000 bit modeling and coding operates on a bit level granularity. This causes much of the increased complexity. The processing steps are mostly sequential and highly conditional making a parallel implementation challenging if not prohibitive.

FIGS. 3 to 6 illustrate flow diagrams for the operations performed in arithmetic encoding. FIG. 3 illustrates Code MPS. FIG. 4 illustrates Code LPS. FIG. 5 illustrates RENORME. FIG. 6 illustrates BYTEOUT.

Code MPS illustrated in FIG. 3 and Code LPS illustrated in FIG. 4 employ several parameters. These are:

A is the arithmetic encoder interval width.

C is the arithmetic encoder codeword.

Qe is the probability associated with a particular symbol context, which is related to likelihood of its occurrence in a stream of data.

CX is a data value used to attach a probability to a data bit in a given bit plane. There are 19 possible context values and 47 different probability values. The coefficient bit modeler determines the value of CX based on the values of the bit's eight nearest neighbors. CX is used as an index to a state array I(CX) that is used to determine which Qe value to load for a given data bit D.

I(CX) is a state array which holds the indices to the Qe probability lookup table. The Qe lookup table has 47 Qe values. The Qe table indices associated with a particular CX value are changed as the arithmetic encoder codes data.

MPS(CX) is the state 1 or 0 of the most probable symbol (MPS) for the context CX. The encoder identifies the input data D as either the Most Probable Symbol (MPS) or Least Probable Symbol (LPS), depending on the current context (CX). The MPS or LPS value may be either 0 or 1, depending on the state of the arithmetic encoder. The MPS for one context could be 0 and the MPS for another context could be 1.

NMPS/NLPS are indices to a new Qe probability index. JPEG2000 defines nineteen context labels that are used to associate probabilities with the MPS and LPS. These probabilities are stored in a look-up table. A context state array is used to identify the MPS value and store the index to the LPS probability estimate Qe look-up table. If a probability Qe associated with a particular context needs to be changed, then the NLPS and NMPS value will contain the indices to that new Qe probability index.

Switch(CX) in a switch indicator value of CX. In a particular situations, the MPS value may need to be inverted from 0 to 1 or from 1 to 0. The switch value is used to test whether or not the inversion needs to be done.

In the JPEG2000 binary arithmetic encoder, C represents the lower bound of the arithmetic encoding interval. A represents the encoding interval width. Depending upon whether an MPS or LPS is coded, a series of mathematical operations such as C=C+(Qe×A) or A=A−(Qe×A) would be needed to update codeword values and interval widths. To simplify operations, JPEG2000 uses renormalization to ensure that the interval width A is always approximately 1. This allows for the prior two equations to be simplified to C=C+Qe or A=A−Qe as shown in blocks 304 and 303 of FIG. 3 and blocks 403 and 404 of FIG. 4.

FIG. 3 illustrates the Code MPS (Most Probable Symbol) procedure 300. Step 301 modifies the arithmetic encoder interval width A replacing it with A−Qe(I(CK)). Then test 302 performs a bit-by-bit AND of A with the value 0×8000 and tests for a zero result.

For a NO at test 302, block 304 sets the lower bound of the encoding interval as necessary by adding the Qe (LPS) probability interval to the codeword C(C=C+Qe(I(CK))). This is the typical path for the MPS procedure as long as there is no need for renormalization.

For a YES result in test 302, test 303 determines if A<Qe(I(CK)). For a YES result in test 303, step 305 recomputes A replacing it with A−Qe(I(CK)). For a NO result in test 303, step 305 recomputes C replacing it with C+Qe(I(CK)). For either result in test 303, step 307 recomputes I(CK) replacing it with NMPS(I(CK)). Following step 307, step 308 calls the RENORME function illustrated in FIG. 5.

FIG. 4 illustrates the CODE LPS (Least Probable Symbol) procedure 400. Step 401 adjusts A by substituting A−Qe(I(CX). Step 402 tests to determine if A is less than Qe(I(CK)). If not (NO at step 402), then since the codeword value C already points to the lower bound of the LPS, only the interval width A needs to be changed for an LPS. This occurs in step 404, where the new interval width A is set equal to the width of the LPS probability Qe or A=Qe(I(CK)). If A less than the Qe of the current LPS (Yes in step 402), the step 403 C=C+Qe(I(CK)). Step 406 tests whether Switch(I(CX)) is 1. This determines whether the inversion of MPS (0 to 1 or 1 to 0) needs to be done. If so (Yes in step 406), then step 409 inverts MPS by MPS=1−MPC(CX). In either case, flow goes to step 407 to set I(CX) equal to NLPS(I(CX). This prepares the individual I(CX) value for renormalization in step 408. The LPS procedure is then complete and exits by done block.

FIG. 5 illustrates the detailed steps that make up the RENORME 500 (block 308 of FIG. 3 and block 408 of FIG. 4). The renormalization procedure ensures that the value of A never strays out of the range of 0.75 to 1.00. This simplifies the arithmetic found in typical arithmetic encoders. The renormalization procedure also determines when the codeword C has a completed byte that needs to be output via the bitstream buffer. Limiting the effective interval width to one eliminates multiplication steps. The value of A is left shifted to keep A in the range of 0.75 to 1.00.

On each call of RENORME 500, step 502 shifts both A and C one bit left and decrements counter CT. Counter CT keeps track of the number of times C and A have been left-shifted. Counter CT is used to determine when the upper bits of C have been filled. The initial value of CT is 8, the number of bits in one byte. Once CT equals zero, eight new bits have been shifted to the upper bits of C, and are now ready to be written to the output bitstream 507.

Step 503 test to determine if CT equals 0. If true (Yes at step 503), then a byte of arithmetically encoded compressed code-block data is sent out for placement into the final bitstream 507 via step 505. If false (No at step 503), then step 508 tests to see if A is loss than or equal to 0×8000. The constant 0×8000 is equivalent to 0.75 in fractional format. If true (Yes at step 508), then A is still not within the correct range. Flow control loops back by path 509 to step 502. If false (No at step 508), then A is now within the range of 0.75 to 1.00. This completes the renormalization process.

FIG. 6 illustrates the flow diagram for the BYTEOUT operation 600 performed in arithmetic encoding according to JPEG2000 specifications. Compressed image data is written to the final bitstream in byte increments. BYTEOUT 600 takes compressed data in the form of individual bytes and places them into the output bitstream buffer. These compressed data bytes are obtained from the arithmetic encoder codeword C.

At a certain point during encoding, the codeword register C becomes full. Codeword C has a size of 32-bits, 28 bits are active. When codeword C becomes full, a byte of data from bits 19-26 (or bits 20-27) of codeword C is placed into the output bitstream buffer. When a MPS (most probable symbol) occurs, the LPS (least probable symbol) probability interval is added to codeword C. On adding these two data values, a may propagate into bits 19-27 of codeword C. This alters what will be the compressed data byte. The temporary data register B exists for this reason. Each time BYTEOUT 600 is called the upper bits of C are placed into B to protect from carries that could propagate from arithmetic on codeword C.

BYTEOUT 600 takes either step 606 or 607 depending upon whether or not bit-stuffing is needed. Bit stuffing prevents carries from propagating and altering incremental codeword bytes that need to be output. In most cases, bits 19-26 are taken as compressed data byte B and placed into the output bitstream. However, a special case can occur when that data byte is equal to 0×FF (all 1's).

Step 601 of BYTEOUT 600 tests for occurrence of all is (0×FF) in byte B from the arithmetic encoder. If B is equal to 0×FF (Yes at step 601), then the carry bit of C (bit 27) has been set, and should be included in the next value of B. In this case, it is bits 20-27 that will represent the next 8-bit byte B, not 19-26. In this case, step 607: increments the bit pointer BP; bits 20 to 27, the carry bits of codeword C are then stored in B (B=C>>20); the vacated bits in C are filled with 1's (C=C & 0×FFFF); and CT is set to 7 so that the bit in bit position 19 can be output in the next byte.

In the case B does not equal 0×FF (No at step 601), then step 602 tests whether or not the carry bit of C is set (C<0×8000000=0). If not (No at step 602), then step 603 increments B (B=B+1). Step 604 tests to determine if the new B is all 1's (B=0FF). Is so (Yes at step 604), then step 605 is a bit-by-bit AND performed with operands C and 0×7FFFFFF. Flow then goes to step 607.

If the result of step 602 is Yes or the result of step 604 is No, then flow goes to step 606. In this case, step 606: increments the bit pointer BP; bits 19 to 26, the carry bits of codeword C are then stored in B (B=C>>19); the vacated bits in C are filled with 1's (C=C & 0×7FFF); and CT is set to 8 so that the bit in bit position 20 can be output in the next byte.

### SUMMARY OF THE INVENTION

This invention is an optimized implementation of the JPEG2000 binary arithmetic encoder on a conventional digital signal processor (DSP) such as the Texas Instruments TMS320C6000. The arithmetic encoder is efficiently software pipelined to obtain fast implementation. A major challenge presented the JPEG2000 standard is the coefficient bit modeler and the arithmetic coder. These modules contain nested loops, nested conditional execution paths and long dependency paths.

The arithmetic coder includes four main stages: code most probable symbol (MPS); code least probable symbol (LPS); renormalization (RENORME); and byte output (BYTEOUT). These stages are executed conditionally based on the context state of the arithmetic coder, its interval width and the codeword value. The encoder must decide if an MPS or LPS is to be encoded, whether to renormalize the interval width and codeword and determine if a compressed byte needs to be extracted from the codeword and output to the embedded bitstream. Adding to the complexity, the RENORME procedure is embedded inside the Code LPS and Code MPS procedures and BYTEOUT is embedded within RENORME.

The present invention includes six major improvements to conventional JPEG2000 encoder implementations. These are: (1) decoupling the co-efficient bit modeling from arithmetic encoding; (2) eliminating a RENORME while loop through least most bit detect; (3) decoupling encoding from BYTEOUT; (4) exploiting parallelism across conditional execution paths; (5) special attention to look-up table storage and packing of context state data; and (6) eliminating memory dependencies through direct register forwarding.

### BRIEF DESCRIPTION OF THE DRAWINGS

These and other aspects of this invention are illustrated in the drawings, in which:

FIG. 1 illustrates the block diagram of the conventional JPEG2000 encoder (Prior Art);

FIG. 2 illustrates the block diagram of the conventional JPEG2000 encoder with an expanded view of the coefficient bit modeler and arithmetic encoder functions (Prior Art);

FIG. 3 illustrates the flow diagram for the code MPS operation performed in conventional arithmetic encoding (Prior Art);

FIG. 4 illustrates the flow diagram for the code LPS operation performed in conventional arithmetic encoding (Prior Art);

FIG. 5 illustrates the flow diagram for the RENORME operation performed in conventional arithmetic encoding; (Prior Art);

FIG. 6 illustrates the flow diagram for the BYTEOUT operation performed in arithmetic encoding according to JPEG2000 specifications; (Prior Art);

FIG. 7 illustrates a block diagram of the JPEG2000 coefficient bit modeler and arithmetic encoder of this invention with an expanded view to illustrate the decoupling of the two functions;

FIG. 8 illustrates a block diagram of the arithmetic coding of a bit plane made more efficient through the use of context/decision pair buffers;

FIG. 9 illustrates simplification of RENORME by elimination of the while loop;

FIG. 10 illustrates decoupling of the encoding and BYTEOUT flow;

FIG. 11 illustrates the manner in which the JPEG2000 arithmetic encoder can exploit parallelism across conditional execution paths;

FIG. 12 illustrates the optimized format for probability look-up tables and context state data;

FIG. 13 illustrates the existence of memory dependencies between CX states across iterations according to the prior art; and

FIG. 14 illustrates the method to eliminate memory dependencies between CX states across iterations by obtaining the updated state data through direct register forwarding.

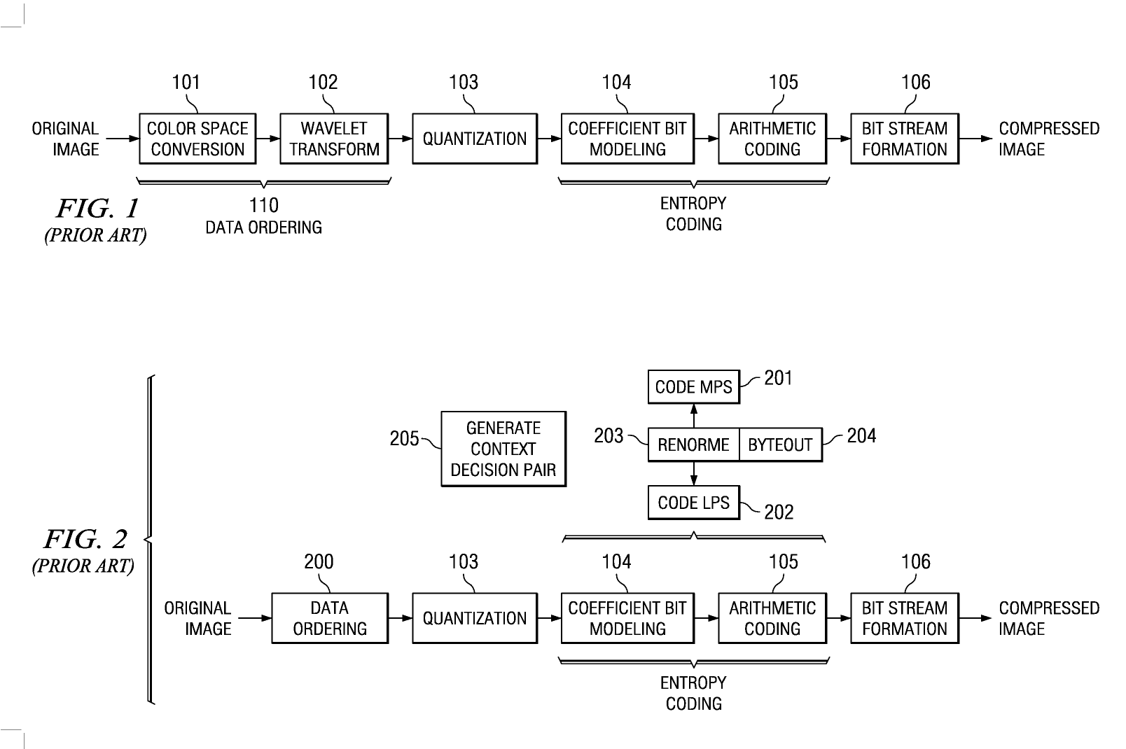

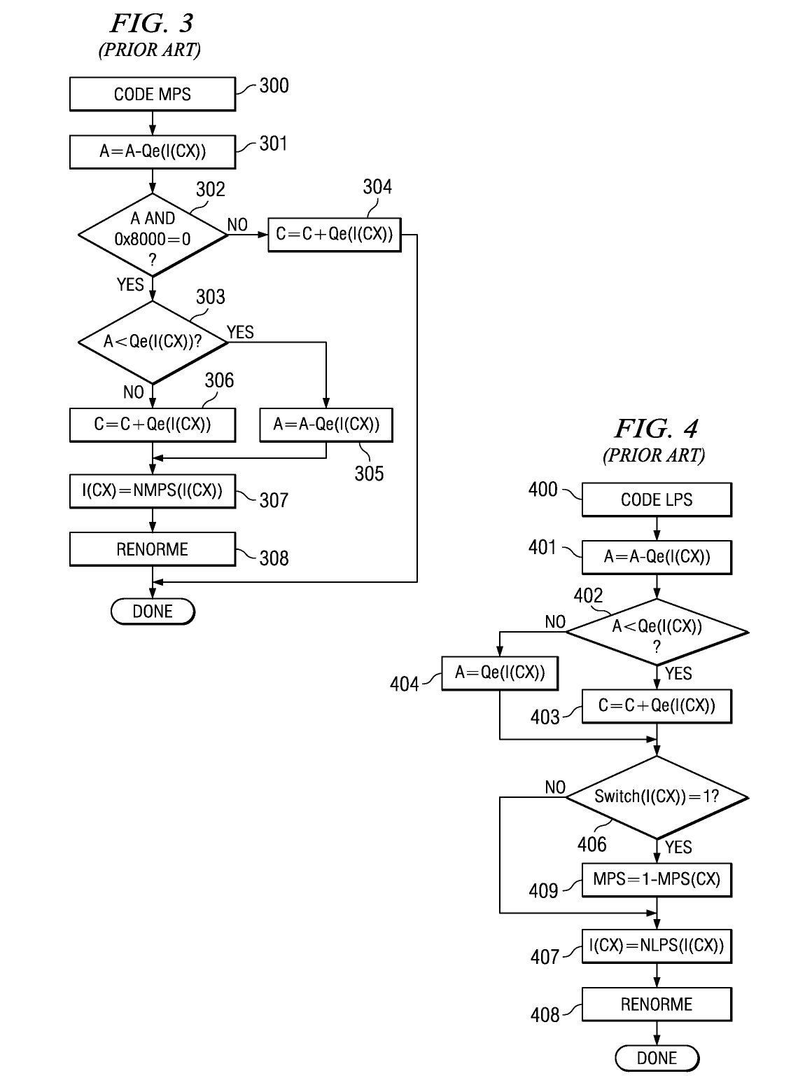

### DETAILED DESCRIPTION OF PREFERRED EMBODIMENTS

The present invention includes six major improvements to conventional JPEG2000 encoder implementations. These are: (1) decoupling the co-efficient bit modeling from arithmetic encoding; (2) eliminating a RENORME while loop through least most bit detect; (3) decoupling encoding from BYTEOUT; (4) exploiting parallelism across conditional execution paths; (5) special attention to look-up table storage and packing of context state data; and (6) eliminating memory dependencies through direct register forwarding.

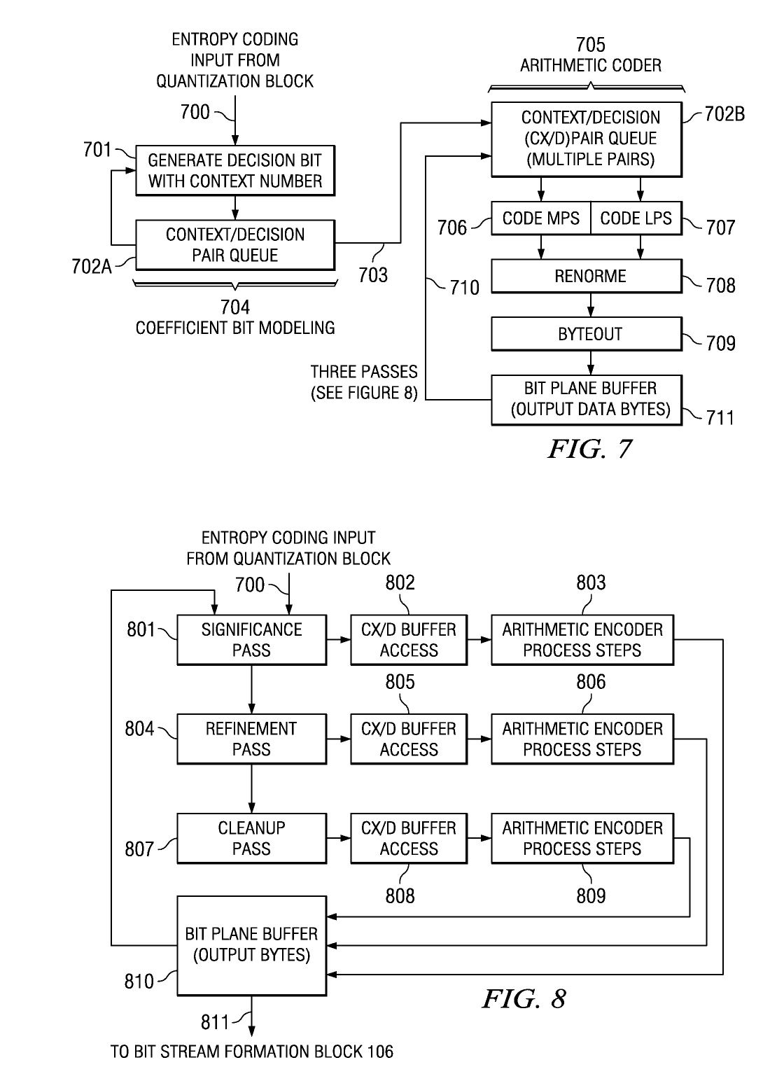

FIGS. 7 and 8 illustrate method for decoupling the coefficient bit modeler from the arithmetic encoder. FIG. 7 illustrates the block diagram of the JPEG2000 coefficient bit modeler and arithmetic encoder of this invention with an expanded view to illustrate the decoupling of the two functions. In a straightforward implementation, the coefficient bit modeler would generate a single decision bit (D) and context number (CX) that are then passed to the arithmetic encoder. In the straightforward implementation, the arithmetic encoder would process one CX/D pair at a time. However, JPEG2000 does not explicitly require coupling of the coefficient bit modeler and arithmetic encoder. To bring the arithmetic encoder into an efficient loop form, bit modeling and arithmetic encoding are decoupled as illustrated in FIG. 7. Entropy coding input data 700 comes from the quantization block 103 and is passed to coefficient bit modeling block 704 for the generation of context number and decision bit pairs (CX/D). Coefficient bit modeling block 704 includes blocks 701 and 702A. Block 701 generates the context number and decision bit pair. These CX/D pairs are queued up in the context/decision pair queue 702A as they are generated. When needed they are sent via path 703 to arithmetic encoder 705 for processing. This allows the arithmetic encoder 105 to operate on multiple CX/D pairs at once. This reduces function call overhead and makes software pipelining the loop possible for further optimization.

Arithmetic coder 705 includes blocks 702B, 706, 707, 708, 708 and 711 and feedback path 710. CX/D pairs are fetched from the context/decision pair queue 702B. For each bit-plane in a code-block, a special code-block scan pattern is used for each of three passes. Each coefficient bit in the bit-plane is coded in only one of the three passes. The arithmetic coder 705 process steps code MPS 706, code LPS 707, RENORME (renormalization) 708 and BYTEOUT 708 are repeated at the end of each pass. The JPEG2000 coefficient bit modeler and arithmetic encoder outputs are completed in block 711.

FIG. 8 illustrates the block diagram of the arithmetic coding of a bit plane made more efficient through the use of context/decision pair buffers. Bit plane output bytes formed in three passes of the process steps 705 through 709 of FIG. 7. The arithmetic coder process steps are depicted in three passes by respective blocks 801 to 803, 804 to 806, and 807 to 809. Outputs from these three passes are stored in the bit plane output buffer 810. The significance pass includes significance pass block 801, CX/D buffer access block 802 and arithmetic encoder process steps 803. The refinement pass includes refinement pass block 804, CX/D buffer access block 805 and arithmetic encoder process steps 806. The cleanup pass includes cleanup pass block 807, CX/D buffer access block 808 and arithmetic encoder process steps 809. Bit plane output bytes 811 are extracted from the bit plane buffer 810 and sent to the bit stream formation block 106 for formation into the full compressed image.

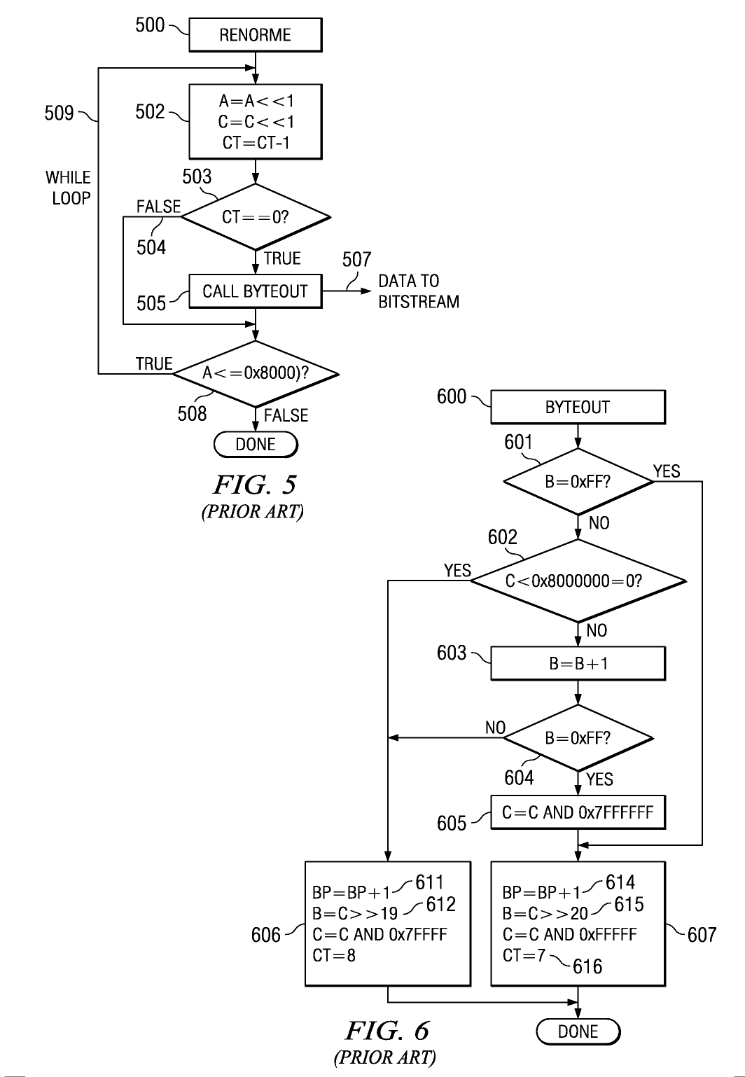

The second optimization method is the elimination of RENORME while loop. The RENORME while inner loop must be eliminated to permit software pipelining in the arithmetic encoder. The arithmetic encoder 705 illustrated in FIGS. 2 and 7) contains a renormalization (RENORME) having a while loop, also illustrated as 509 of FIG. 5, which is used to keep the interval width A above 0×8000. In this while loop, the value of A is left-shifted by one and tested to see if (A<0×8000) during each iteration. This while loop 509 can be eliminated by having the processor implement an instruction that can determine the number of left-most zeros present in A. Renormalization can then be realized by performing the appropriate number of bit-shifts

The arithmetic encoder implementation according to the methods of this invention achieves software pipelining on the Texas Instruments C64X series digital signal processing (DSP) architecture. Software pipelining enables the most effective use of the parallel resources of the processor and achieves the highest performance.

The C64X series DSPs employ a very long instruction word (VLIW) architecture that can execute up to eight instructions per central processing unit (CPU) clock cycle. Eight functional units can perform operations such as load, store, add, subtract and multiply in parallel. The C64X DSP also employs software pipelining, which allows for multiple iterations of a loop to execute in parallel. Pipelining is scheduled in software prior to code execution, so code should be written to achieve the best compiler optimization. Factors that can prevent code from pipelining include function calls, nested if/else constructs, complex control code, function calls, and branching. The JPEG2000 arithmetic encoder contains several of these obstacles in its native description. The methods of the present invention are directed to overcome these obstacles.

Consider the while loop 509 in the RENORME procedure of FIG. 5, which arises from test step 508. The goal is elimination of repetitive loops in the arithmetic encoder. Software pipelining executes multiple iterations of a loop in parallel. On the C64x DSP, the compiler schedules loop code such that future loop iterations are executed concurrently with the present iteration. For any loop to pipeline on the DSP, it cannot contain inner loops or an unknown number of loop iterations. Both of these factors are present in the RENORME procedure of FIG. 5. The RENORME procedure acts as an inner loop to the CODE MPS and CODE LPS procedures. The RENORME procedure also contains an unknown number of iterations as determined by the number of left-shifts needed to normalize A. The purpose of the RENORME procedure in FIG. 5 is to keep the interval width A between the floating point values 0.75 and 1.0. The RENORME procedure is performed when coding an LPS or when the value of A falls below 0×8000 when coding an MPS. In the RENORME procedure the value of A and C are left-shifted by one until A becomes greater than 0×8000.

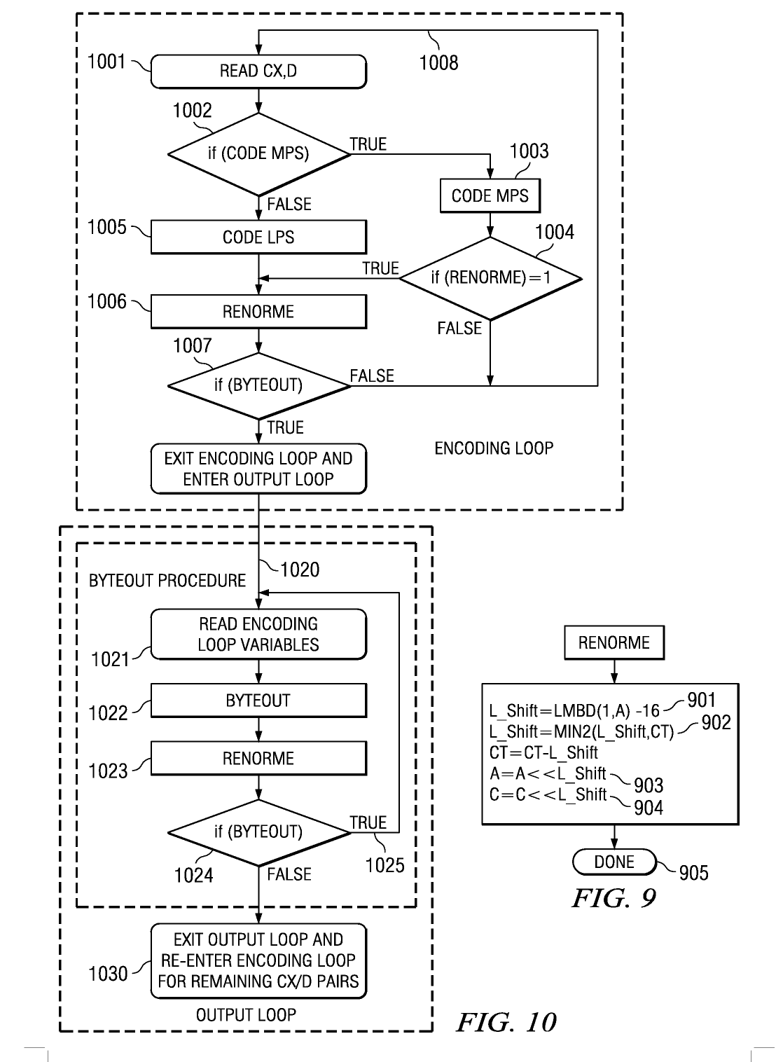

FIG. 9 illustrates an optimization step of this invention transforms the RENORME procedure so that it is no longer a while loop. Instead of proceeding through this while loop, it is possible to immediately determine the number of left-shifts required to bring A above 0×8000 using the C64X LMBD (left-most bit detect) instruction. This instruction yields the number of left-most zeros in a register, thus indicating the needed amount of left-shifts. Operations 901 and 902 determine the value of L_Shift. Operation 901 determines how many left-most zeros are in register A. Operation 902 sets L_Shift to the smaller of the prior L_Shift and CT. CT is a down counter keeping track of loop count. Once the number of left shifts (L_Shift) is know, it is possible to perform all of the necessary shifts at once, instead of a single left-shift per while-loop iteration. Two simultaneous operations 903 and 904 left shift both C and A by the amount L Shift.

FIG. 5 illustrates that the RENORME procedure must output a byte of compressed data from buffer C to the output bitstream buffer, if the codeword buffer C is full. This is done in the BYTEOUT procedure. This is the third optimization method of the present invention. The encoding in Code MPS, Code LPS and RENORME are decoupled from BYTEOUT. Because the BYTEOUT procedure is executed infrequently and at a low symbol rate, it can be merged with renormalization into a separate loop. Only after a certain number of bits have been encoded does BYTEOUT append the encoded bits to the bitstream. Therefore further optimization should be targeted at the encoding rather than the BYTEOUT portion of the processing. Note that the transformation has to be done in a way such that renormalization is performed in both the new loop in block 1023 and the encoding loop in block 1006 (FIG. 10). Removing operations for BYTEOUT from the encoding procedure has the additional benefit of making the encoding loop more efficient. The encoding loop can then be iterated as often as possible via path 1008 until a byte has to be output. The loop is then terminated and the output or BYTEOUT loop is entered via path 1020. After that encoding resumes. In a straightforward implementation of the JEPG2000 algorithm, the BYTEOUT loop would normally have to perform re-normalization as well, preventing parallel execution with the encoding loop.

FIG. 10 illustrates the two loops resulting from decoupling encoding from BYTEOUT. The number of times BYTEOUT must be called is only about 5% of the total number of symbols encoded. The optimization here is targeted at encoding rather than the BYTEOUT function. In FIG. 10, the encoding loop includes steps 1001 through 1008. The two loops are created with renormalization is performed in both. The first loop encodes a binary decision based on the Code MPS 1003 and Code LPS 1005 procedures. Renormalization occurs in step 1006 if necessary. This first loop is the encoding loop. If BYTEOUT is called by the true result in test 1007, the encoding loop exits. The second loop or output loop is entered via path 1020 to perform a BYTEOUT and complete renormalization (RENORME). The RENORME 1023 in the output loop will execute any left-shifts of A and C that were not completed prior to calling BYTEOUT. Simultaneously the encoding loop can iterate via 1008 as often as necessary until a true result in step 1007 indicates a byte must be output. The encoding loop exits at step 1010 and enters the output loop is entered. Completion of the output loop re-enters the encoding loop via step 1030.

Removing the operations for BYTEOUT from the encoding procedure has the additional benefit of making the encoding loop more efficient. Cycle penalties for exiting the encoding loop to enter the output loop are negligible, since this occurs very infrequently. FIG. 9 illustrates the modified RENORME function. The test step 503 (CT==0?) from FIG. 5 now becomes an exit condition 905 for the encoding loop instead of a test embedded in RENORME.

Now consider the fourth optimization method of the present invention. This involves exploiting parallelism across conditional execution paths. The length of a recurrence path in the encoding loop determines its iteration interval. The optimization steps described below reduces this path to a smaller iteration interval and a more efficient software pipelined schedule.

The JPEG2000 algorithm is restructured to minimize the number of different conditional execution paths permitting more parallelism. This in turn shortens the recurrence path. This is achieved by: (1) determining which instructions can be executed speculatively; (2) minimizing the number of predication registers required; and (3) minimizing the number of conditional expressions required.

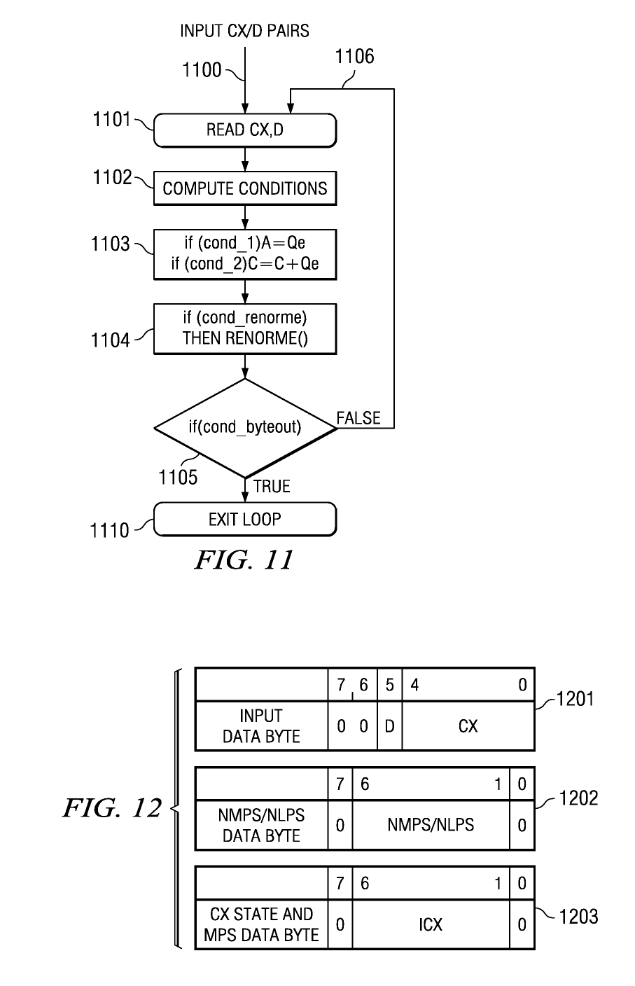

FIG. 11 illustrates the manner in which the JPEG2000 arithmetic encoder can exploit parallelism across conditional execution paths. Step 1101 reads the input context/decision pairs into the encoding process. Step 1102 computes all relevant conditions governing the encoding process. The majority of the code flow is directed by these two conditions which are based on whether a LPS or MPS is coded, and upon the value of A with respect to Qe and the constant 0×8000. Some of these conditions can be computed in parallel.

The two computations of the arithmetic encoder (A=Qe) and (C=C+Qe) are common to Code MPS and Code LPS. These conditions are reduced to two: cond_1 and cond_2. Step 1104 subjects these conditions to separate tests. In step 1103 these tests update A and C as follows:

If(cond_1)is true, replace A by Qe
If(cond_2)is true, replace C by C+ Qe.

Step 1104 determines if renormalization is necessary. This test yields:

If(cond_renorme)is true, perform renormalization.

Test step 1105 determines that another iteration is necessary via path 1106 upon a false result. If test step 1105 yields a true result, then exit loop 1110 is entered.

As a fifth optimization method, the present invention addresses the need for an optimum storage format in memory for context state data that minimizes the number of operations required to read, store and extract the individual elements. FIG. 12 illustrates the storage format of this invention. The storage format includes a probability look-up table that reduces the number of operations needed for extracting probabilities and indexes. This further shortens the recurrence path. NMPS, Qe, NLPS, and SW are stored in the look-up table using the AC_LUT procedure 1200 of FIG. 12. The AC_LUT code is as follows:

| typedef struct | |
|---|---|
| { | |
| unsigned short NMPS; | // Index to Next Most Probable |
| | Symbol (NMPS) [symbol] bits 6–1 |
| unsigned short Qe; | // Least Probable Symbol (LPS) |
| | probability |
| unsigned short NLPS; | // Index to Next Least Probable |
| | Symbol (NLPS) [symbol] bits 6–1 |
| unsigned short SW; | // Switch state for current |
| | lookup table (LUT) index |

//
} AC_LUT;

Context (CX) and decision (D) pairs are packed into one byte 1201 conserving memory space. Byte 1202 shows NMPS and NLPS indices stored in bits 1 through 6 in corresponding look-up table registers. Storing NMPS and NLPS in these bit locations allows for efficient updates to the CX state array during symbol encoding. Byte 1203 shows the manner of storing MPS and ICX. Updates to the CX state array are accomplished by using an OR instruction to pack the current MPS value into bit 0 of the local NMPS/NLPS register. The CX state array is updated with the modified NMPS/NLPS register since it will contain the MPS and the next possible Qe index in the same byte.

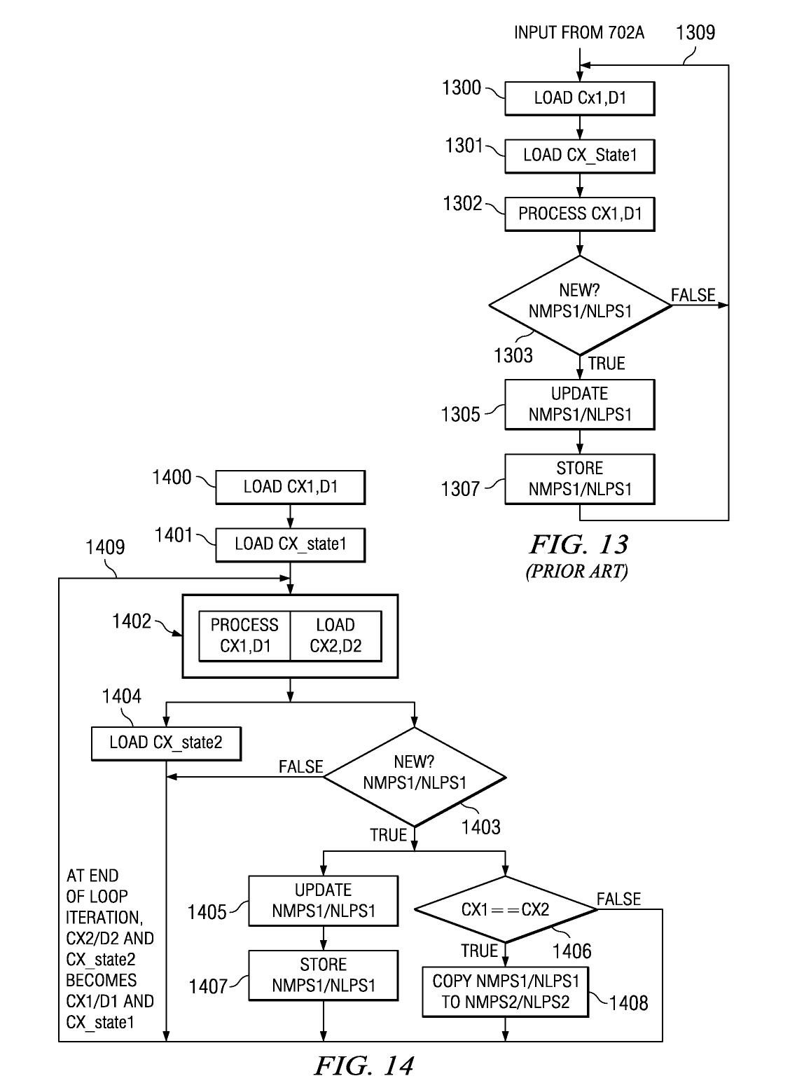

The sixth and final optimization method of the present invention addresses the need for eliminating memory dependencies through direct register forwarding. FIG. 13 illustrates the memory dependencies between CX states across iterations in a straightforward implementation of memory load, store, and update processes relating to the arithmetic encoder operations.

Step 1300 loads the initial context Cx1 and data D1. The recurrence steps 1301 through 1307 contain a memory dependency involving storing the updated state information before the state information can be loaded for the next iteration. There is a memory dependency if the same context is used again in the next iteration. Note that there is no dependency if different contexts are involved. In that case the context for the next iteration can be read before the context of the previous iteration was updated in memory.

Step 1301 loads the state 1 context CX_State1. Step 1302 processes the context Cx1 and data D1. This results in a determination of a most probable symbol (MPS) or a least probable symbol. This result in not relevant to the operation illustrated in FIG. 13. Test step 1301 determines if a new Most Probable Symbol (NMPS1) or a new Least Probable Symbol (NLPS1) is required. If not, then the process loops back to step 1300 via path 1309. If so, then step 1305 updates the new Most Probable Symbol (NMPS1) and the new Least Probable Symbol (NLPS1) and step 1307 stores these values. The process then loops back to step 1300 via path 1309. Note that if a new Most Probable Symbol (NMPS1) and the new Least Probable Symbol (NLPS1) are required, then these must be stored and required before the load operation of step 1300. This is the memory dependency.

The memory dependency that exists in the case of the same context occurring consecutively can be eliminated by obtaining the updated state data for the next iteration directly from the register written to by the previous iteration rather than from memory. This effectively replaces the load operation and all associated delay slots in the recurrence path with a simple register move operation.

The efficiency of software pipelined loops is strongly affected by data dependencies across loop iterations. FIG. 14 illustrates the methodology for elimination of these memory dependencies between CX states across iterations by obtaining the updated state data through direct register forwarding.

FIG. 14 begins with step 1400 which loads the initial context Cx1 and data D1 and step 1401 which loads the state1 context CX_State1. These steps correspond to steps 1300 and 1301 of FIG. 13. Step 1402 operates two processes in parallel. The first operation processes the context Cx1 and data D1. This results in a determination of a most probable symbol (MPS) or a least probable symbol. The second operation loads the context Cx2 and data D2 for the next iteration. How this second operation is may execute in parallel is described below.

Test step 1403 determines if a new Most Probable Symbol (NMPS1) or a new Least Probable Symbol (NLPS1) is required. If not, then the process loops back to step 1402 via path 1409. If so, then step 1405 updates the new Most Probable Symbol (NMPS1) and the new Least Probable Symbol (NLPS1) and step 1407 stores these values. In parallel with this memory operation, test step 1406 determines if the next context is the same as the prior context (CX1==CX2). If so, then no memory dependency occurs and the process loops back to step 1402 via path 1409. If the context differs, then step 1408 copies the prior NMPS1 and NLPS1 to the register for the next NMPS2 and NLPS2. This register copy operation bypasses the memory dependency. Process returns to step 1402 via path 1409. Step 1404 loads the state2 context CX_State2 in parallel with test step 1403. These steps enable the memory dependency of using a changed context to be hidden.

If the next loop iteration depends on a data value of the previous loop iteration, then the start of that future iteration cannot begin until that data value is computed. This occurs when loading and updating CX states during encoding. For example, the first loop iteration loads CX state 1 and uses it to encode the data symbols. If the CX state requires updating, its new CX state value is determined and stored in the same memory location as the old value. If the CX state used in the next loop iteration is not the same as the state used in the current iteration, then that state, CX state 2 could be loaded before the completion of encoding for CX state 1 and before any needed update to CX state 1. However, if the CX states used in the current and next iteration are the same, then the next CX state value cannot be loaded until the previously updated state has been stored. One way to avoid this dependency is to load the CX state for iteration 2 regardless of what is occurring for iteration 1. This is followed by testing to see if the next iteration uses an updated state value of the current iteration. If this is true, then the current iteration CX state value (CX state 1) is copied over directly to the register that is storing the incorrect value of CX state 2. This optimization is referred to as direct register forwarding. FIG. 14 illustrates the methodology for elimination of memory dependencies between CX states across iterations by obtaining the updated state data through direct register forwarding. Direct register forwarding 1404 via path 1408 allows for the loading of the context state for the next iteration to occur prior to the storage of potential context state updates for the current iteration. Flow from the test 1303 yielding a true result in FIG. 13 is replaced by the dual path 1405/1407 and 1406/1408. Direct register forwarding the load step 1404 can be used because dependencies with different contexts are involved. In that case the context for the next iteration can be read before the context of the previous iteration was updated in memory.

Performance results show an average 2.4 times speed-up when the optimization methods of the present invention are applied when compared to the straightforward C version and assembly version of the arithmetic encoder. Further benchmarks show an average 33% speed-up of the overall JPEG2000 encoder.

These methods have been described in the context of JPEG2000 arithmetic encoding, however some of the described methods are also applicable to the JPEG2000 arithmetic decoder and to other non-JPEG2000 arithmetic encoders. Most other optimization methods are based on devising a dedicated hardware implementation. Other DSP software implementations described in proposed methodology do not attempt to craft the arithmetic encoder exploiting parallelism to any degree. The methods of the present invention facilitate implementation employing TMS320C6000 commercial off-the-shelf digital signal processors thereby allowing system designers to avoid having to resort to custom hardware designs.

What is claimed is:

1. A method of binary arithmetic coding that encodes a bit as either a most probable symbol or a least probable symbol comprising the steps of:
decoupling the encoding decision from the mainstream coding operations by queuing pairs of decision bits; and
performing pipelined encoding.

2. The method of claim 1, further comprising the steps of:
transferring predetermined bit lengths of encoded output data by accumulating data within an inner decision loop;
testing to determine whether predetermined bit lengths of data are available for output;
exiting the encoding loop and outputting any available data if all remaining data is available as predetermined bit lengths of data; and
returning to continue loop if further data not in predetermined bit lengths remains to be encoded.

3. The method of claim 1, further comprising the steps of:
speculatively encoding both the most probable symbols and the least probable symbols in plural parallel functional units;
speculatively encoding both most probable symbol and least probable in parallel in plural function units;
determining whether to encode the most probable symbols or the least probable symbol; and
committing the determined most probable symbol or least probable symbol and discarding the other symbol.

4. The method of claim 1, further comprising the steps of:
upon encoding a most probable symbol or a least probable symbol storing updated state information for context in a memory data and storing processor data in a register; and
determining whether a next symbol encoding context is updated or new;
if said context is new, then reading new context from memory; and
if said context is updated, then reading new context from the data register.
